(19) United States
(12) Patent Application Publication
(10) Pub. No.: US 2010/0119026 A1
(43) Pub. Date: May 13, 2010

(54) Method for Determining the Three-Dimensional Power Distribution of the Core of a Nuclear Reactor

(76) Inventors: Antoine Gautier, Paris (FR); David Durey, Versailles (FR)

Correspondence Address: FAY KAPLUN & MARCIN, LLP, 150 BROADWAY, SUITE 702, NEW YORK, NY, 10038, US

(21) Appl. No.: 12/531,605

(22) PCT Filed: Mar. 14, 2008
(86) PCT No.: PCT/FR2008/050446

§ 371 Date: Dec. 2, 2009

(30) Foreign Application Priority Data
Mar. 19, 2007 (FR) 0701965

(51) Int. Cl. G21C 17/10; G21C 7/36

(52) U.S. Cl. 376/216; 376/254

(57) ABSTRACT

A method determines a volumetric power distribution of a core of a nuclear reactor using a set of detectors for measuring a neutronic flow provided outside the reactor vessel, and a set of probes for measuring the temperature of the coolant at the outlet of the fuel assemblies. The method comprises the step of determining a first volumetric power distribution using a neutronic calculation code instantaneously solving the diffusion equation and updating the isotopic balance of the core during the fuel depletion based on values of the core operation parameters, and the step of determining a new volumetric power distribution by adjusting the first volumetric power distribution using the measures provided by the sensors for measuring the neutronic flow and provided outside the reactor vessel and by the temperature measuring probes.

The present invention relates to a method for determining the three-dimensional power distribution of the core of a nuclear reactor. Another object of the invention is a method for monitoring at least one limiting parameter of the normal operation of the nuclear reactor core. The invention is more particularly adapted to pressurized water nuclear reactors.

In normal operation, the core of a nuclear reactor must respect certain conditions that guarantee the compliance of safety criteria in case of an accident. These conditions (known as category 1 conditions) correspond to the initial situations taken in safety studies; exceeding them during normal operations thus undermines the demonstration of safety. Continuously verifying the compliance of normal operation limits defines the “monitoring of pre-accidental conditions of the core” function.

These conditions are formulated from parameters representative of a particular activation of constituent fuel rods of the nuclear reactor core. By way of example may be cited simple parameters, such as the power level of the core or factors representative of the power distribution form (ΔI, FΔH, etc.) but also more advanced parameters, such as the Critical Heat Flux Ratio (associated with the critical boiling phenomenon) or the linear power density (associated with the fuel melting phenomenon). Monitoring the pre-accidental conditions of the core thus is done by calculating one or more of these parameters and by comparison to a predefined threshold, issued from safety studies. When the parameters chosen to define the monitoring function are simple, penalizing assumptions must also be taken to cover the high number of pre-accidental situations corresponding to a threshold value of these parameters. The compatibility of these penalizing assumptions with safety criteria compliance in accident studies requires the normal operating range of the reactor core to be reduced. It thus appears that a refinement of the monitoring function, that is to say the use of more advanced parameters to define the normal operation limits of the reactor core, allows the normal operating range of the reactor core to be extended and therefore allows operations to be saved.

The counterpart of monitoring function refinement is the need to have an on line method of evaluating the advanced parameter on which it is based. Such being the case, this evaluation most often necessitates access to an image of the power distribution produced in the nuclear reactor core. There again, the simpler the means used to access this image of the power distribution in the core, the higher the associated conservatism and the more truncated the normal operating range of the reactor core. Most of the methods used today to monitor the normal operating limits of the core of a nuclear reactor reconstitute an image of the power distribution in the core by combining a two-dimensional radial image with a one-dimensional axial image.

Methods of restoring the core power distribution in three dimensions are also known.

However, these methods necessitate the addition of additional instrumentation in the core.

In this context, the object of the present invention is to mitigate the aforementioned disadvantages and the invention aims to provide a method for determining the three-dimensional power distribution of the core, which is efficient and that does not need additional instrumentation to be added.

For this purpose, the invention proposes a method for determining the three-dimensional power distribution of the core of a nuclear reactor implemented by a programmed device, said core comprising a plurality of fuel assemblies by using a set of detectors for measuring a neutron flux provided outside the reactor vessel and a set of probes for measuring the temperature of the coolant at the outlet of said fuel assemblies, said method comprising the following steps:
determining a first three-dimensional power distribution by using a neutronic calculation code instantaneously solving the diffusion equation and updating the isotopic balance of the core during fuel depletion based on values of the core operation parameters,
determining a new three-dimensional power distribution by adjusting said first three-dimensional power distribution using the measurements issued by said neutron flux measuring detectors disposed outside the reactor vessel and said temperature measuring probes.
continuously controlling said neutronic calculation, said control comprising the following steps:
calculating, at time step tᵢ, the current three-dimensional power distribution of the core from parameter values characterizing the current operation of the reactor.
calculating, at time step tᵢ, a new three-dimensional power distribution after adjusting one or more parameter or parameters characterizing the current operation of the reactor to minimize the discrepancy between calculation and measurement of the axial imbalance of the mean power on a set of assemblies at the periphery of the core.
using the new power distribution issued from the previous calculation as the initial condition of the neutronic calculation at the following time step tᵢ₊₁.

“Instantaneous” is understood to refer to a neutronic calculation carried out for each time step with a time step of less than one minute (on the order of 30 seconds).

Thanks to the invention, the power distribution may be accessed in the core from three-dimensional information provided by a neutronic calculation performed on line. This information is corrected by the measurements issued from the existing instrumentation (thermocouples and probes outside the reactor vessel, known as excore) on pressurized water reactors to account for all specificities of the core at the time of calculation. The method does not necessitate any additional instrumentation. The result of this correction is a three-dimensional image of the current power distribution of the core that serves as a basis for determining advanced limiting parameters of normal operation (for example Departure of Natural Boiling Ratio, known as DNBR, and linear power).

Thus, since it performs a three-dimensional neutronic calculation of the current power distribution of a nuclear reactor core, since it allows this three-dimensional calculation to be combined with measurement information continuously provided by the existing instrumentation and since it is based on the result of this calculation of a limiting parameter of the normal operation of the reactor core combination, on the reactor site and in a time compatible with the requirements of the on line core monitoring function, the method according to the invention allows precise and efficient monitoring of the pre-accidental conditions of the reactor core with minimal impact on the nuclear unit equipment, and thus allows savings to be released that are usable for optimized exploitation of the nuclear unit.

The objective of continuous neutronic calculation control is to optimize the representation by the neutronic code of transient phenomena having a direct impact on core power distribution.

The method according to the invention may also present one or more of the characteristics below, considered individually or according to any technically possible combinations.

According to a preferential embodiment, the determining a new power distribution step comprises the following steps:
a first step of adjusting the first calculated power distribution, the adjustment being carried out by a mathematical function minimizing the discrepancies between the axial component of the calculated power distribution and the measurements issued by the “excore” neutron flux measurement detectors outside the vessel.
a second step of adjusting the first calculated power distribution, the adjustment being carried out by a mathematical function minimizing the discrepancies between the radial component of the calculated power distribution and the measurements issued by the temperature measurement probes.

Preferentially, the reconstruction method according to the invention comprises a step of periodically correcting the core model at the root of the neutronic calculation code, this periodical correction comprising a step of modifying the parameters intrinsic to the core model to minimize the discrepancies between the three-dimensional power distribution calculated by the neutronic code and the three-dimensional power distribution deduced from the measurements provided by neutron flux measurement detectors inside the reactor core, known as incore probes.

Another object of the present invention is a method for monitoring at least one limiting parameter of the normal operation of the nuclear reactor core comprising the following steps:
implementing the method of determining the three-dimensional power distribution of said core according to the invention.
calculating at least one limiting parameter of the normal operation of the reactor core from this three-dimensional power distribution of the core.
calculating the discrepancy of the calculated parameter with relation to a predetermined threshold.

Thus, the power distribution reconstructed by the method according to the invention is used as a support to the calculation of at least one limiting parameter of normal reactor core operation, whose margin with relation to a predefined limit may thus be restored on line and wherein the monitoring may allow an alarm to be set off in case this limit is exceeded.

Advantageously, the monitoring method comprises an alarm activation step in the control room in case the threshold is exceeded by the calculated parameter.

Advantageously, the limiting parameters of normal reactor core operation are chosen from the following parameters: linear power, known as Plin, Departure of Natural Boiling Ratio, known as DNBR, axial power imbalance, known as Dpax and azimuthal power imbalance known as Dpaz.

The different calculated parameters, power distribution or even calculated margins may also be continuously displayed on one or more control room screens.

Another object of the present invention is a computer program comprising programming means for the execution of the method according to the invention when the computer program is executed on a computer.

Other characteristics and advantages of the invention will clearly emerge from the description that is given below, for indication and in no way limiting purposes, with reference to the attached figures, among which:

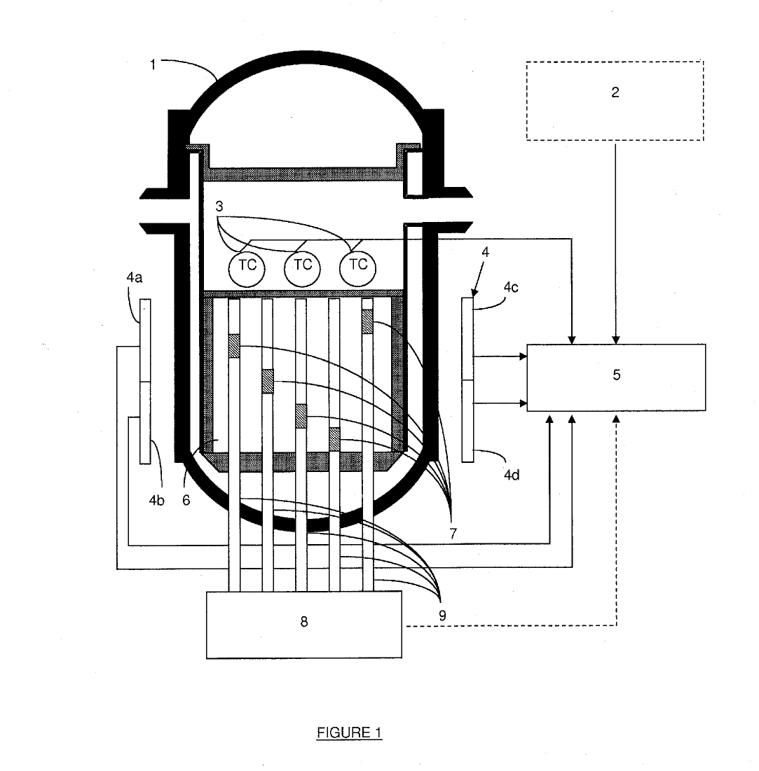

FIG. 1 schematically represents the vessel of a pressurized water reactor illustrating the implementation of the method according to the invention;

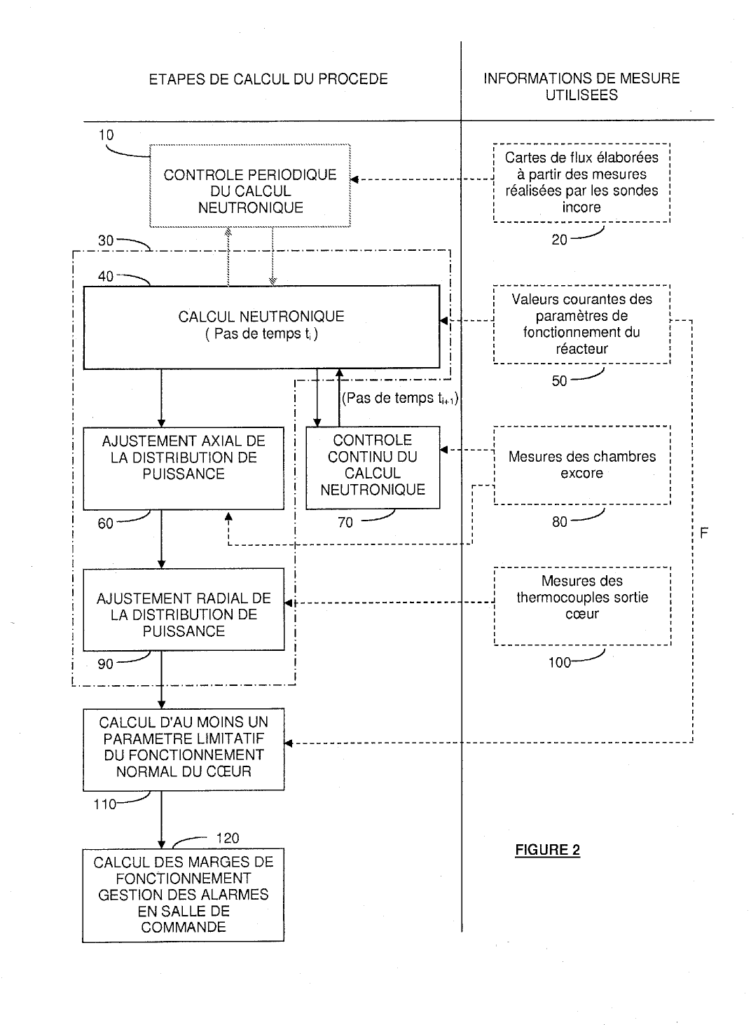

FIG. 2 is a block diagram of the different steps of the method according to the invention.

FIG. 1 schematically represents a vessel 1 of a pressurized water reactor.

Vessel 1 comprises a core 6 equipped with fuel assemblies and is equipped with:
probes for measuring the temperature of the refrigerant (or coolant) at the outlet of the constituent fuel assemblies of core 3 (called core outlet thermocouples).
chambers for measuring the neutron flux external to the core 4 (called excore chambers).
instrumentation internal to the core 8 constituted of incore probes 7.

The core monitoring method according to the invention is implemented by a programmed device 5. This monitoring method is based on the calculation of at least one limiting parameter of the normal operation of core 6 of the reactor from a three-dimensional distribution of the current core 6 power, determined from a three-dimensional neutronic calculation and measurements provided by existing instrumentation on pressurized water reactors (PWR) that are chambers for measuring the neutron flux external to core 4 and core outlet thermocouples 3.

The excore chambers 4 comprise several measurement stages 4a, 4b (for example six stages, only two being represented in FIG. 1) along the height of core 6 and are generally disposed at the periphery of core 6, in four positions symmetrical with relation to two axial symmetry planes of core 6 forming between them a 90° C. angle. The staggered chambers 4a to 4d of the excore detectors thus allow neutron flux measurements at different levels along the height of core 6 in four zones distributed around core 6 at different azimuths to be obtained. The excore chambers 4 thus provide axial and azimuthal type information on the power distribution of core 6. It will be noted that the figure represents two excore chambers 4 at two stages, respectively 4a-4b and 4c-4d but that four excore chambers are most often used, particularly on 1300 MWe power reactors (with six stages per chamber) and 900 MWe power reactors (with two stages per chamber).

The core outlet thermocouples 3 form a network in the horizontal plane, that is, perpendicular to the height of core 6, and are installed above and facing the fuel assemblies. The core outlet thermocouples 3 thus allow the temperature of the coolant at the outlet of certain constituent fuel assemblies of core 6 (known as instrumented assemblies) to be measured. The temperature of the coolant at the fuel assembly outlets is linked to the nuclear power produced by these assemblies, core outlet thermocouples 3 thus providing radial type information on the power distribution of core 6.

To calibrate these two instrumentations 4 and 3 and to make sure that their response is representative of what they should measure, measurements are periodically performed with “incore” instrumentation internal to core 8, constituted of incore probes 7, that are generally mobile fission chambers that issue three-dimensional measurement information. The incore probes 7 are each fixed to the end of a flexible cable known as a Teleflex cable, ensuring its displacement inside a measuring channel 9. The image that incore probes 7 periodically provide of the three-dimensional power distribution in core 6 is known as a flux map.

In the monitoring method according to the invention, these flux maps serve as a basis for determining the adjustment coefficients of excore measurements and thermocouples so that they are representative of the peripheral axial power distribution and of the coolant temperature at the outlet of the assemblies, respectively. Peripheral axial power distribution is understood to refer to the weighted average of axial power distributions per assembly on a set of assemblies near the periphery of core 6. The method according to the invention may use the quantity of peripheral axial imbalance (also known as “axial offset”) designating the weighted average of the axial power offset on a set of assemblies near the core 6 periphery as a replacement for this peripheral axial power distribution.

The programmed device 5 for the implementation of the core monitoring method according to the invention thus disposes information from:
thermocouples 3,
excore chambers 4,
incore instrumentation 8.

The programmed device 5 also disposes current values 2 of reactor operation parameters (for example the average thermal power of the core, the average input temperature of the coolant in the vessel and the controlled position of the control groups).

To describe in further detail the monitoring method according to the invention, a block diagram is offered in FIG. 2 that represents, in a first column, the sequence of steps for implementing the monitoring method according to the invention and, in a second column, the measurement information used at each step.

The steps grouped together in box 30 designate the steps of the three-dimensional power distribution reconstruction or determination method of the core according to the invention.

This reconstruction method 30 uses the excore measurements 80 and the thermocouple measurements 100, adjusted on the flux maps by means of calibration coefficients.

This reconstruction of the three-dimensional power distribution 30 is based on the sequence from a phase 40 of calculating the power distribution by a neutronic code and of two phases 60 and 90 of adjusting the power distribution calculated on the excore 80 and thermocouple 100 measurements.

The power distribution calculation phase 40 implements a three-dimensional neutronic code that, from current reactor 50 operational parameter values (for example the average thermal power of the core, the average input temperature of the coolant in the vessel and the controlled position of the control groups), updates the isotopic balance of the core during fuel depletion and solves on line the diffusion equation to restore the three-dimensional distribution of the current core power, under the form of a set of nuclear power values in different points distributed in the core. By way of example, the SMART neutronic calculation code based on advanced nodal type 3D modeling may be cited. The principles of core neutronic calculation are described in further detail in the document “Méthodes de calcul neutronique de cœur” (Techniques de l'ingénieur—B3070—Giovanni B. Bruna and Bernard Guesdon).

The first adjustment phase 60 of the power distribution from excore measurements 80 implements a mathematical process intended to bring together peripheral axial power distributions or axial offsets issued from the calculation and the axial power distributions or the peripheral axial offsets measured by the excore chambers 80 calibrated on the flux maps. The algorithm implemented differs according to whether the information used is of the axial power distribution type or of the axial offset type (these two terms may be grouped together under the generic term of axial three-dimensional power distribution component).

If the information used is of the axial power distribution type, the algorithm uses a method of the “least squares” type to restore a vector of N_{Z} corrective coefficients (N_{Z} being the number of axial meshes from the core model at the root of the neutronic calculation code) to apply to the axial power distribution of each assembly to minimize the discrepancies between calculation and measurement on the peripheral axial power distribution. This algorithm is applied for the four available pairs (calculated peripheral axial power distributions, measured peripheral power axial distribution). Four corrective coefficient vectors are thus restored, each vector being associated with an excore chamber. The axial power distribution of each core assembly is then corrected by a linear combination of these four vectors, the coefficients of this linear combination being correlated with the distance from the assembly to the four excore chambers, guaranteeing compliance of the average core power.

If the information used is of the axial offset type, the algorithm restores a function of the

$${\sum }_{i = 1}^{N} α ( i ) {sin}^{i} ( 2 π \cdot f ( z ) )$$

type to apply to the axial power distribution of each assembly to minimize the discrepancy between calculation and measurement on the peripheral axial offset. This function may be seen as a vector of N_{Z} corrective coefficients where N_{Z} is the number of axial meshes of the core model at the root of the neutronic calculation code. The function f(z) intervening in the definition of this corrective function is parameterable and predefined. The coefficients α(i) and the digit N are obtained by an iterative process. This algorithm is applied for the four available pairs (calculated peripheral axial offset, measured peripheral axial offset). Four vectors of corrective coefficients are thus restored, each vector being associated with an excore chamber. The axial power distribution of each core assembly is then corrected by a linear combination of these four vectors, the coefficients of each linear combination being correlated with the distance from the assembly to the four excore chambers and guaranteeing compliance of the average core power.

The second adjustment phase of the power distribution 90 (from thermocouple measurements 100) implements a mathematical process intended to bring together the average powers of instrumented assemblies, such as calculated by the neutronic code and such as deduced from coolant temperatures measured at the outlet of these assemblies by thermocouples 100 calibrated on flux maps. The algorithm uses a method of two-dimensional polynomial regression and restores a corrective function to apply to the radial power distribution to minimize the discrepancies between calculation and measurement on the power of instrumented thermocouple assemblies. This corrective function may be seen as a set of Nₐₛₛ corrective coefficients, where Nₐₛₛ is the number of nuclear reactor core assemblies.

This method of determining the three-dimensional power distribution of the core 30 according to the invention that has just been described as the sequence of a calculation phase 40 and of two adjustment phases 60 and 90 is applied during the nuclear reaction operation, with a periodicity on the order of 30 seconds. Approximately every 30 seconds, a three-dimensional distribution of the current power of the reactor core is therefore restored by the method according to the invention. This power distribution may be seen as a set of Nₐₛₛ×N_{cray}×N_{Z} nuclear power values in different points distributed in the core, where Nₐₛₛ is the number of constituent assemblies of the core, N_{cray} is the number of constituent fuel rods of an assembly and N_{Z} is the number of axial meshes from the core model at the root of the neutronic calculation code.

This new three-dimensional distribution of the current core power is used for implementing the monitoring method according to the invention which allows the calculation 110 of limiting parameters of the normal nuclear reactor core operation and in particular the parameters defined below:
Plin: linear power, that is, the power per unit of length of the core fuel elements.
DNBR: Departure of Natural Boiling Ratio, representative of the discrepancy of the coolant thermohydraulic conditions with relation to a critical boiling situation.
Dpax: Axial power imbalance in the core (or axial power offset)
Dpaz: Azimuthal power imbalance in the core (or power tilt).

The limiting normal operation parameters of the core calculated by the monitoring method according to the invention are compared to threshold values defined in safety studies. This comparison allows margins (step 120) to be calculated with relation to the threshold values and possibly, in case a threshold value has been crossed, an alarm signal in the nuclear reactor control room to be developed. It will be noted that the calculation of some limiting parameters may require knowledge of current reactor 50 operational parameter values that do not constitute direct input data necessary for neutronic calculation 40 (hence the presence of arrow F): this is the case, for example, of the DNBR, that requires knowledge of flow and pressure data that are not necessarily input data for neutronic calculation 40. The different parameters calculated, power distribution or even margins calculated may also be displayed continuously on one or more control room screens.

The reconstruction method 30 according to the invention, such as described until now, allows on line calculation of a power distribution according to step 40 and of an adjustment according to steps 60 and 90 to reduce as much as possible discrepancies with relation to the excore 80 and thermocouple 100 measurements, representative of the real core power distribution at the time of calculation. This calculated power distribution, once adjusted on the measurements, is thus representative of the physical specificities of the core at the time of calculation and is used as a support to the calculation 110 of limiting normal operation parameters of the core for which margins in relation to predefined threshold limits may then be evaluated according to step 120.

The accuracy of the adjusted power distribution, that is, its conformance with the real core power distribution, requires the discrepancies between calculation and measurement used in the power distribution adjustment phases 60 and 90 to be controlled. In fact, when the discrepancies between calculation and measurement are outside a certain range where the effectiveness of the power distribution adjustment process is optimal, the accuracy of the adjusted power distribution deteriorates. To maintain the discrepancies between calculation and measurement in the optimal effectiveness range of the power distribution 60 and 90 adjustment method, the method of determining the core 30 three-dimensional power distribution according to the invention provides the possibility of acting on the calculation in two distinct ways:
a continuous control of the neutronic calculation 70,
a periodical control of the neutronic calculation 10.

The objective of the continuous neutronic calculation 70 control is to optimize the representation by the neutronic code of transient phenomena having a direct impact on core power distribution, notably xenon distribution oscillations in the reactor core. This control mode is implemented on line in the method according to the invention and thus may be activated with the same periodicity as that appropriate for the power distribution 30 reconstruction process according to the invention described above (approximately 30 seconds). This is an iterative process that is based on a modification of the value of one or more operation parameter or parameters used at the input of the neutronic calculation 50 (for example, the average thermal power of the core, the average input temperature of the coolant in the vessel and the controlled position of the control groups). At each calculation time step tᵢ, the peripheral axial offset of the calculated (but not yet adjusted on the measurement) power distribution is compared to the peripheral axial offset measured by the excore chambers 80. If the discrepancy between calculation and measurement on the peripheral axial offset does not satisfy a predefined criterion, a modification of the value of one or more operation parameter or parameters 50 is carried out and a new neutronic calculation is performed by the code with the modified parameter or parameters value. In other words, the value of one or more operation parameters is thus forced to a value that is not necessarily representative of reality. This operation is repeated until the criterion on the discrepancy between calculation and measurement on the peripheral axial offset is satisfied. When this iteration is achieved, the power distribution is said to be controlled. This controlled power distribution is used as an initial condition for the neutronic calculation at the following time step tᵢ₊₁. It should be noted that the control process 70 of the calculated power distribution is carried out in parallel with the reconstruction process 30 described above. In other words, the adjustment on the measurements 60 and 90 inherent to the reconstruction process 30 is carried out on the power distribution calculated with unmodified operation parameter values 50 used at the input of the neutronic calculation 40, that is, representative of reality.

The objective of the periodical control of the neutronic calculation 10 is to optimize the representation by the neutronic code of stationary phenomena or phenomena with slowly developing kinetics having a direct impact on core power distribution, particularly depletion or moderation imbalances inside the nuclear reactor core. This mode of control is based on the use of flux maps obtained periodically from measurements carried out by incore probes 20. This mode of control may thus be activated with the same periodicity as that suitable for flux maps (typically on the order of a month). This is an iterative process that is based on a modification of parameters intrinsic to the three-dimensional core model at the root of the neutronic calculation code. Parameters intrinsic to the core model are understood to refer to parameters intervening in the diffusion equation. These parameters are thus modified iteratively until a criterion on the discrepancies between the power distribution calculated by the code and the power distribution corresponding to the flux map is satisfied. A resetting of the neutronic code on the flux map is thus performed periodically in this way. Between two consecutive resettings of the neutronic code (approximately one month apart), the neutronic calculations performed at each time step for the reconstruction process 30 or the continuous control process 70 described previously use modified values of parameters intrinsic to the core model, such as obtained during the last resetting performed.

The two methods of controlling the neutronic calculation 10 and implemented in the method according to the invention thus guarantees a certain level of compliance of the calculated power distribution with the real power distribution of the core. This level of compliance between the calculated and real power distributions is necessary for maintaining the power distribution reconstruction process 30 performance whatever the normal operation transient phenomena to which the reactor is subjected (load following, control point adjustment or extended operation at reduced power, for example) or the physical specificities of the core (depletion imbalance of the fuel or moderation for example). The power distribution 30 reconstruction process then acts as a fine power distribution adjustment on the continuous measurements provided by the excore instrumentation 80 and the thermocouple instrumentation 100. This mixed action on the neutronic calculation of controls 10 and 70 on the one hand and adjustments 60 and 90 on the other hand respectively establishes the soundness and accuracy of the pre-accidental condition monitoring of the reactor core performed by the method according to the invention.

Of course, the invention is not limited to the embodiment that has just been described. Thus, the invention was described for four excore chambers but the number of chambers may vary.

In addition, even if the invention was more particularly described in the case of a pressurized water reactor, the invention may apply to any type of reactor comprising a core equipped with probes for measuring the temperature and excore instrumentation.

Any means may be replaced by an equivalent means.

1-8. (canceled)

9. A method for determining a three-dimensional power distribution of a core of a nuclear reactor implemented by a programmed device, the core including a plurality of fuel assemblies by using a set of neutron flux measurement detectors disposed outside a vessel of the reactor and a set of probes measuring a temperature of a coolant at an outlet of the fuel assemblies, the method comprising the following steps:
determining a first three-dimensional power distribution by using a neutronic calculation code instantaneously solving a diffusion equation and updating an isotopic balance of the core during fuel depletion, from values of reactor operation parameters;
determining a new three-dimensional power distribution by adjusting the first three-dimensional power distribution with measurements issued by the neutron flux measurement detectors disposed outside the reactor vessel and the temperature measurement probes; and
continuously controlling the neutronic calculation, the control comprising the following steps:
calculating, at time step ti, a current three-dimensional power distribution of the core from values of parameters characterizing a current operation of the reactor,
calculating, at time step ti, a new three-dimensional power distribution after adjusting at least one parameter characterizing the current operation of the reactor to minimize a discrepancy between a calculation and a measurement of an axial power imbalance averaged over a set of assemblies at a periphery of the core, and
using the new power distribution issued from the previous calculation as an initial condition of the neutronic calculation at a following time step ti+1.

10. The method according to claim 9, wherein the determining the new power distribution step comprises the following steps:
adjusting the first calculated power distribution, the adjustment being carried out by a mathematical function minimizing discrepancies between an axial component of the calculated power distribution and the measurements issued by the neutron flux measurement detectors disposed outside the vessel; and
adjusting the first calculated power distribution, the adjustment being carried out by a mathematical function minimizing discrepancies between a radial component of the calculated power distribution and the measurements issued by the temperature measurement probes.

11. The method according to claim 9, further comprising:
periodically correcting a core model at a root of the neutronic calculation code,
wherein the periodical correction step includes the following substeps:
modifying parameters intrinsic to the core model to minimize discrepancies between the distribution of the three-dimensional power calculated by the neutronic code and the distribution of three-dimensional power deduced from the measurements provided by the neutron flux measurement detectors inside the reactor vessel.

12. A method for monitoring at least one limiting parameter of a normal operation of a core of a nuclear reactor, the core including a plurality of fuel assemblies by using a set of neutron flux measurement detectors disposed outside a vessel of the reactor and a set of probes measuring a temperature of a coolant at an outlet of the fuel assemblies, comprising the following steps:
(A) determining a three-dimensional power distribution of the core, the determining step including the following substeps:
determining a first three-dimensional power distribution by using a neutronic calculation code instantaneously solving a diffusion equation and updating an isotopic balance of the core during fuel depletion, from values of reactor operation parameters;
determining a new three-dimensional power distribution by adjusting the first three-dimensional power distribution with measurements issued by the neutron flux measurement detectors disposed outside the reactor vessel and the temperature measurement probes; and
continuously controlling the neutronic calculation, the control comprising the following steps:
calculating, at time step ti, a current three-dimensional power distribution of the core from values of parameters characterizing a current operation of the reactor,
calculating, at time step ti, a new three-dimensional power distribution after adjusting at least one parameter characterizing a current operation of the reactor to minimize a discrepancy between a calculation and measurement of an axial power imbalance averaged over a set of assemblies at a periphery of the core, and
using the new power distribution issued from the previous calculation as an initial condition of the neutronic calculation at a following time step ti+1;
(B) calculating at least one limiting parameter of a normal operation of the reactor core from the new three-dimensional power distribution of the core; and
(C) calculating a discrepancy of the parameter calculated with relation to a predetermined threshold.

13. The method according to claim 12, further comprising:
triggering a control room alarm when the threshold has been exceeded by the calculated parameter.

14. The method according to claim 12, wherein the at least one limiting parameter of the normal operation of the reactor core is one of the following parameters: a linear power density (known as Plin), a Critical Heat Flux Ratio (known as DNBR), an axial power imbalance (known as Dpax), and an azimuthal power imbalance (known as Dpaz).

15. The method according to claim 12, wherein one of the at least one calculated parameter, the new power distribution and the calculated discrepancy are continuously displayed on at least one control room screen.

16. A computer readable storage medium including a set of instructions for determining a three-dimensional power distribution of a core of a nuclear reactor implemented by a programmed device, the core including a plurality of fuel assemblies by using a set of neutron flux measurement detectors disposed outside a vessel of the reactor and a set of probes measuring a temperature of a coolant at an outlet of the fuel assemblies, the set of instructions being executable by a processor, the set of instructions operable to:
determine a first three-dimensional power distribution by using a neutronic calculation code instantaneously solving a diffusion equation and updating an isotopic balance of the core during fuel depletion, from values of reactor operation parameters;
determine a new three-dimensional power distribution by adjusting the first three-dimensional power distribution with measurements issued by the neutron flux measurement detectors disposed outside the reactor vessel and the temperature measurement probes; and
continuously control the neutronic calculation, the control instruction comprising instructions operable to:
calculate, at time step ti, a current three-dimensional power distribution of the core from values of parameters characterizing a current operation of the reactor,
calculate, at time step ti, a new three-dimensional power distribution after adjusting at least one parameter characterizing the current operation of the reactor to minimize a discrepancy between a calculation and a measurement of an axial power imbalance averaged over a set of assemblies at a periphery of the core, and
use the new power distribution issued from the previous calculation as an initial condition of the neutronic calculation at a following time step ti+1.

17. A computer readable storage medium including a set of instructions for monitoring at least one limiting parameter of a normal operation of a core of a nuclear reactor, the core including a plurality of fuel assemblies by using a set of neutron flux measurement detectors disposed outside a vessel of the reactor and a set of probes measuring a temperature of a coolant at an outlet of the fuel assemblies, the set of instructions being executable by a processor, the set of instructions operable to:
(A) determine a three-dimensional power distribution of the core, the determining instruction including instructions operable to:
determine a first three-dimensional power distribution by using a neutronic calculation code instantaneously solving a diffusion equation and updating an isotopic balance of the core during fuel depletion, from values of reactor operation parameters;
determine a new three-dimensional power distribution by adjusting the first three-dimensional power distribution with measurements issued by the neutron flux measurement detectors disposed outside the reactor vessel and the temperature measurement probes; and
continuously control the neutronic calculation, the control instruction comprising the instructions operable to:
calculate, at time step ti, a current three-dimensional power distribution of the core from values of parameters characterizing a current operation of the reactor,
calculate, at time step ti, a new three-dimensional power distribution after adjusting at least one parameter characterizing a current operation of the reactor to minimize a discrepancy between a calculation and measurement of an axial power imbalance averaged over a set of assemblies at a periphery of the core, and
use the new power distribution issued from the previous calculation as an initial condition of the neutronic calculation at a following time step ti+1;
(B) calculate at least one limiting parameter of a normal operation of the reactor core from the new three-dimensional power distribution of the core; and
(C) calculate a discrepancy of the parameter calculated with relation to a predetermined threshold.
